(19) United States
(12) Patent Application Publication
(10) Pub. No.: US 2026/0232150 A1
(43) Pub. Date: Aug. 13, 2026

(54) MULTIFUNCTION TOILET WITH INCINERATING AND OPTIONAL HEATING, AND DISTILLATION MEANS

(71) Applicant: Lawrence Hilton, Alpine, UT (US)

(72) Inventor: Lawrence Hilton, Alpine, UT (US)

(21) Appl. No.: 19/401,231

(22) Filed: Nov. 25, 2025

Related U.S. Application Data
(60) Provisional application No. 63/724,895, filed on Nov. 25, 2024.

(51) Int. Cl. A47K 11/02

(52) U.S. Cl. CPC A47K 11/023

(57) ABSTRACT

A toilet is provided having an incinerator, and optional distillation and heating means, comprising a revolving cylinder with a plurality of crucibles/chambers. In various embodiments, heat used in incinerating human waste which heat is then diverted to power one or more of a water distillation device and a heater for residential or commercial buildings.

### BACKGROUND OF THE INVENTION

### Field of the Invention

This invention relates to toilets, water distillation and home heating systems, and more particularly relates to an incinerating toilet with residential heating and water distillation function.

### Description of the Related Art

The treatment of human waste has become a problem in various rural areas where sewage treatment plants are inaccessible as well as campsites, construction sites, cabins, and barns on large farm lands, and general homes without sewage treatment facilities which often field drains or septic tanks for human waste. For this reason, means for storing waste in a tank or the like, transferring the tank from the tank to a vacuum car and transporting it to the processing equipment, or replacing the entire tank and transporting it to the processing equipment, has been the norm in the art.

Although versions of incinerating toilets are known, they are not efficient. The heat used to incinerate the waste is not repurposed.

It is an object of the present invention to provide an incinerated flush toilet device that can incinerate defecation efficiently and can repurpose the heat used for incinerator function. Accordingly, the below teachings are provided.

### SUMMARY OF THE INVENTION

From the foregoing discussion, it should be apparent that a need exists for a multifunction toilet with optional incinerating, heating and distillation means. Beneficially, such an apparatus would overcome many of the difficulties and safety concerns expressed.

The present invention has been developed in response to the problems and needs in the art that have not yet been fully solved by currently available apparati and methods. Accordingly, the present invention has been developed to provide a multifunction toilet, the toilet comprising: a toilet bowl defining a hollowing cylindrical recess dimension to receive a chamber wheel; a cylinder defining a plurality of concave crucibles positioned at regularly-spaced intervals around a central axis of the cylinder, each crucible defining an open top end; wherein the cylinder is partially disposed beneath a receptacle of the toilet bowl; wherein the cylinder is operable to rotate when a lid is closed and to cycle the crucible; wherein the toilet bowl defines a hollow interior cooling recess operable to cool a temperature of an adjacent crucible; wherein the toilet bowl defines a hollow interior heating chamber operable to heat a temperature of an adjacent crucible; and a dispenser operable to dispense incinerated human waste material into a waste disposal receptacle.

The cylinder may rotate about a horizontal axis. The cylinder may rotate about a vertical axis.

The multifunction toilet may further comprise an incinerator operable to incinerate human waste material in a crucible.

In some embodiments, the multifunction toilet further comprises a water distillation apparatus heated by exhaust from the incinerator.

The multifunction toilet may further comprise a central heater heated by exhaust from the incinerator.

A second multifunction toilet is provided, the toilet comprising: a toilet bowl defining a hollowing cylindrical recess dimension to receive a chamber wheel; a cylinder defining a plurality of concave crucibles positioned at regularly-spaced intervals around a central horizontal axis of the cylinder, each crucible defining an open top end; wherein the cylinder is partially disposed beneath a receptacle of the toilet bowl; wherein the cylinder is operable to rotate when a lid is closed and to cycle the crucible; wherein the toilet bowl defines a hollow interior cooling recess operable to cool a temperature of an adjacent crucible; wherein the toilet bowl defines a hollow interior heating chamber operable to heat a temperature of an adjacent crucible, the hollow interior heating chamber surrounded by heating elements; and a dispenser operable to dispense incinerated human waste material into a waste disposal receptacle.

The multifunction toilet may further comprise a water tank filled with vapor from one of: evaporated human waste and an external water supply. In still further embodiments, the multifunction toilet comprises a valve for inputting water into the toilet.

The heating chamber may define a drainage opening connected to a drain pipe.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a sectioned, side perspective view of a multifunction toilet apparatus and system for in accordance with the present invention;

FIG. 2 is a sectioned, side perspective view of a multifunction toilet apparatus and system for in accordance with the present invention;

FIG. 3 is a top perspective view of a multifunction toilet apparatus and system for in accordance with the present invention;

FIG. 4 is a forward perspective view of a multifunction toilet apparatus and system for in accordance with the present invention;

FIG. 5 is a sectioned, side perspective view of a multifunction toilet apparatus and system for in accordance with the present invention;

FIG. 6 is a top perspective view of a cylinder of a multifunction toilet apparatus and system for in accordance with the present invention;

FIG. 7 is a top perspective view of a cylinder of a multifunction toilet apparatus and system for in accordance with the present invention;

FIG. 8 is a side perspective view of a cylinder of a multifunction toilet apparatus and system for in accordance with the present invention;

FIG. 9 is a side perspective view of a cylinder of a multifunction toilet apparatus and system for in accordance with the present invention;

FIG. 10 is a top perspective view of a cylinder of a multifunction toilet apparatus and system for in accordance with the present invention;

FIG. 11 is an elevational frontal-side perspective view of a multifunction toilet apparatus and system for in accordance with the present invention;

FIG. 12A is a top perspective view of a cylinder of multifunction toilet apparatus and system for in accordance with the present invention;

FIG. 12B is a top perspective view of a cylinder of a multifunction toilet apparatus and system for in accordance with the present invention;

FIG. 13 is a sectioned side perspective view of a multifunction toilet system for in accordance with the present invention;

FIG. 14 is a sectioned side perspective view of a multifunction toilet system for in accordance with the present invention;

FIG. 15 is a flowchart of a method purposing heat for beneficial processing of human waste in accordance with the present invention; and

FIG. 16 is a block diagram of a system purposing heat for beneficial processing of human waste in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

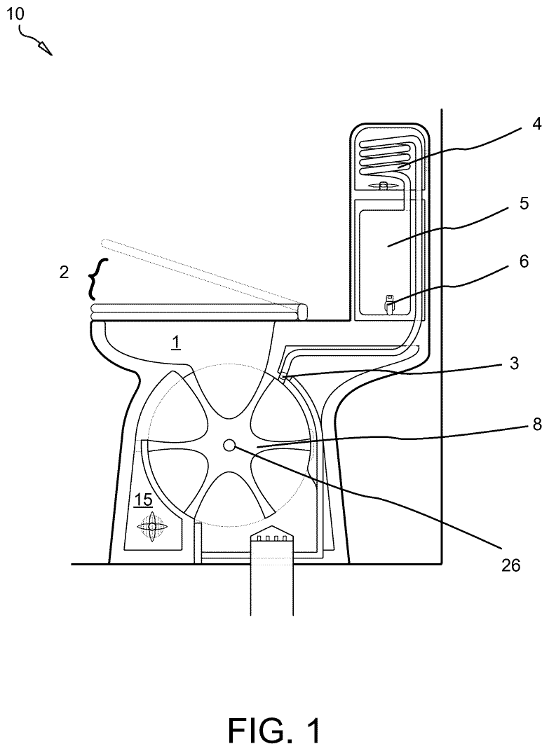

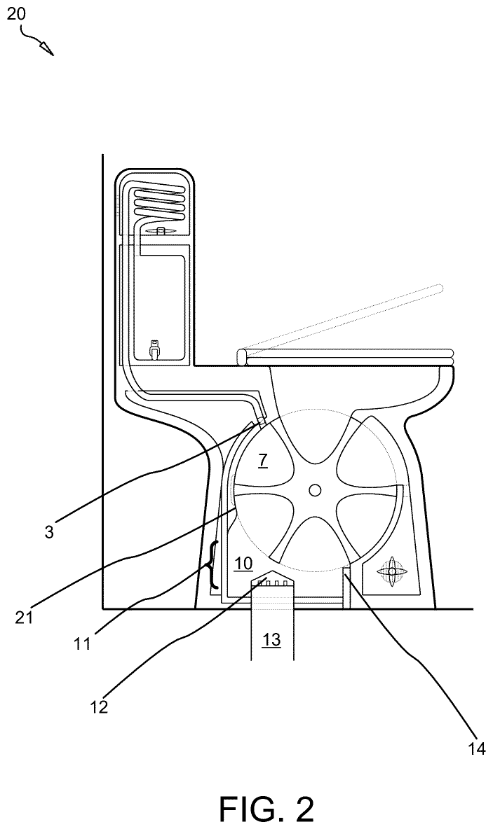

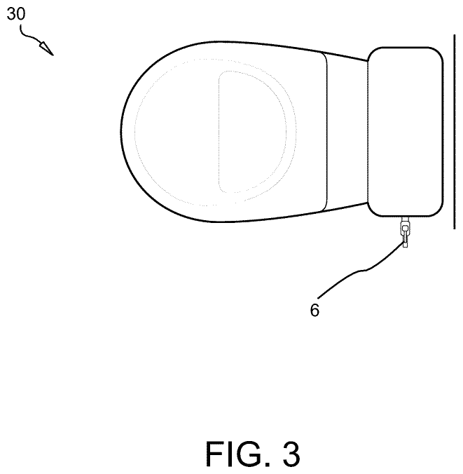

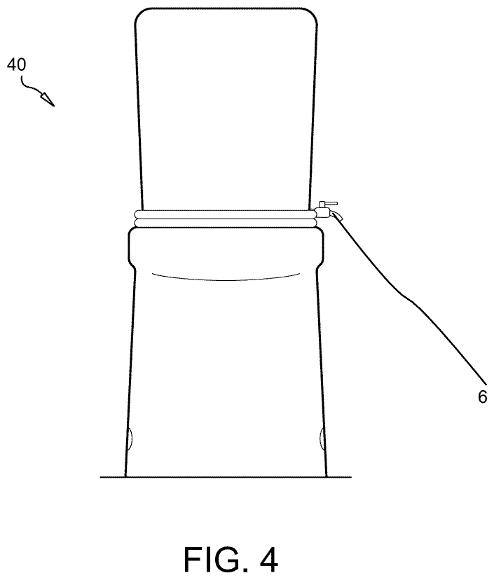

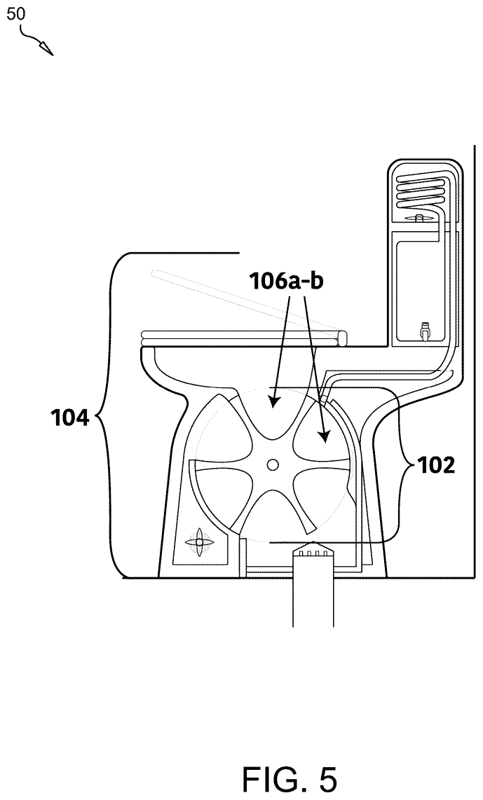

FIGS. 1-5 illustrate sectioned, side perspective views of a multifunction toilet apparatus and system 10, 20 for in accordance with the present invention.

The apparatus 10, 20 comprises a toilet bowl 104 defining a hollow cylindrical recess 21 in which a chamber wheel (i.e., cylinder) rotates axially. As shown, the chamber wheel 8, 102 may rotate about a horizontal axis 26, but alternatively may rotate about a vertical axis.

The chamber wheel 8 defines a plurality of incineration chambers 7, 106. The incineration crucibles 7 (i.e., chambers 7) each define a concave recess with an open top end. The incineration crucibles 7 may be conical, ovoid, frustoconical, or otherwise shaped. The chamber wheel 8 may comprise a plurality of crucibles 7, 106, between three and seven.

The chamber wheel 8 rotates like a cylinder of a revolver. The chamber wheel 8 rotates such that an incineration crucible 7 is positioned directly beneath an open bottom end of the receptacle 1 of the toilet bowl 104.

In various embodiments, each crucible 7 comprises a liner or sleeve detachable insertable into the crucible, which contours an interior surface of the crucible, which is removable for cleaning and replacement.

In various embodiments, the toilet bowl 104 defines an internal cooling recess 15 forward of the chamber wheel 8 into which cooled air may be pumped or which ambient air at a lower temperature operates to reduce a temperature of crucibles 7 rotating on the wheel.

The lid 103 closes over the top open end of the receptacle 1, however the lid 103 operates as a lever in some embodiments, mechanically rotating the chamber wheel 8 such that each chamber revolves one position with the closure of the lid 103. In various embodiments, the lid 103 is affixed to a ratcheting mechanism known to those of skill in the art. In other embodiments, the lid is affixed to a switch which causes an electric motor to rotate the chamber wheel 8 one position when activated.

The apparatus 100, 200 comprises, in some embodiments, a steam pressure release valve 3, which may be a one-way check valve. A water is boiled off from receiving waste, the heated water vapor may exit the valve 3 into a closed system used to perform one or more of the following functions: (1) distill the water vapor, (2) distill external water input into the system 10, 20; (3) be ejected from jets 14 to clean crucibles 7; and (4) heat ambient air or external systems.

The apparatus 10, 20 may comprise water distiller tubes 4 which may be arranged helically to heat a recess and/or water within a recess of the apparatus 10, 20.

The apparatus 10, 20 may comprise a tank 5 for housing distilled water, said tank 5 having a facet 6 or valve for dispensing the distilled water to an external source. In some embodiments, the valve 6 is used to input water into the system 10, 20 and pressurize the system including the jet(s) 14.

In some embodiments, the hollow cylindrical recess 21 comprises concave baffles 9 recessed into the toilet bowl 104 operable to allow air and/or vapor flow between adjacent crucibles 7. The baffles 9 may be connected to tubes which direct heated air to other parts of the apparatus 10, 20.

The toilet bowl 104 defines a hollow interior heating recess 10. When a crucible 7 is rotated into position adjacent to the heating recess 10, the heating recess 10 operates at sufficiently high temperatures to incinerate waste in the crucible 7.

The heating recess 10 may be surrounded by heating elements 11. These heating elements 11 may comprise resistive wires for converting electrical energy into heat or tubes in which heated air has been previously passed from crucibles, distilling operations, or other internal or external components.

A lower surface of the heating recess 10 may comprise a drainage opening 12 through which incinerated waste may be disposed. In various embodiments, the incinerated waste falls into the drainage opening 12. In other embodiments, the waste is sucked from the heating chamber 10 using negative pressure in a drainage pipe 13 which may be disposed beneath the drainage opening 12.

The apparatus 10, 20 may also comprise a water jet 14 operable to dispense pressurized water into a crucible adjacent to the heating chamber 10. This water originate internally or externally to the apparatus 10, 20.

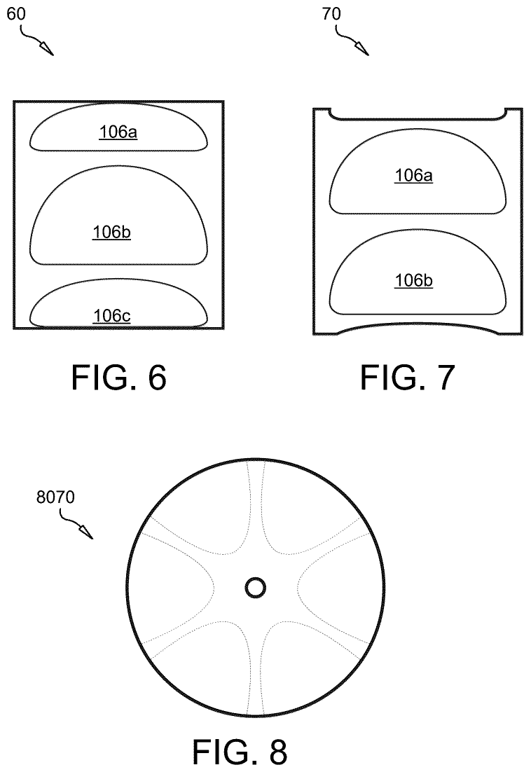

FIG. 6 is a top perspective view of a cylinder 60 of a multifunction toilet apparatus and system for in accordance with the present invention.

The crucibles 7, 106 are shown. In various embodiments, the concave recess defining the crucible 106 is not of uniform shape, but may appear as hemispherical from a top perspective. The chamber wheel 8 in the shown embodiment consists of six crucibles 106.

FIG. 7 is a top perspective view of a cylinder 8 of a multifunction toilet apparatus and system 70 for in accordance with the present invention.

The chamber wheel 8 in the shown embodiment consists of five crucibles 106.

FIG. 8 is a side perspective view of a cylinder 8 of a multifunction toilet apparatus and system for in accordance with the present invention.

The chamber wheel 8 in the shown embodiment consists of six crucibles 106.

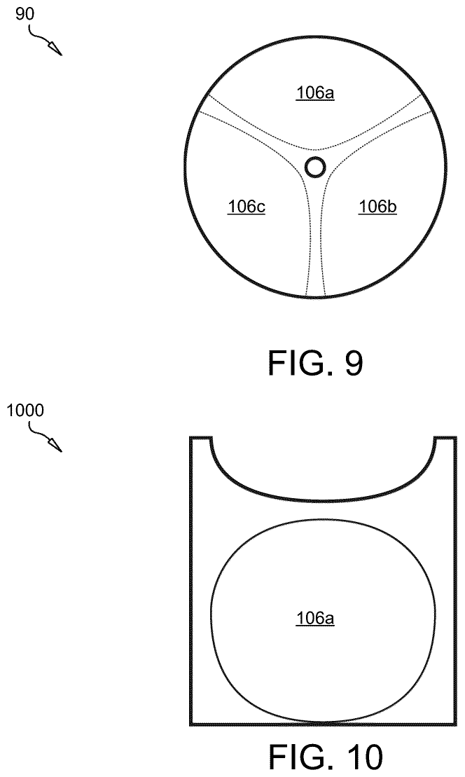

FIG. 9 is a side perspective view of a cylinder 8 of a multifunction toilet apparatus and system for in accordance with the present invention.

The chamber wheel 8 in the shown embodiment consists of three crucibles 106.

FIG. 10 is a top perspective view of a cylinder of a multifunction toilet apparatus and system for in accordance with the present invention.

The chamber wheel 8 in the shown embodiment consists of three crucibles 106.

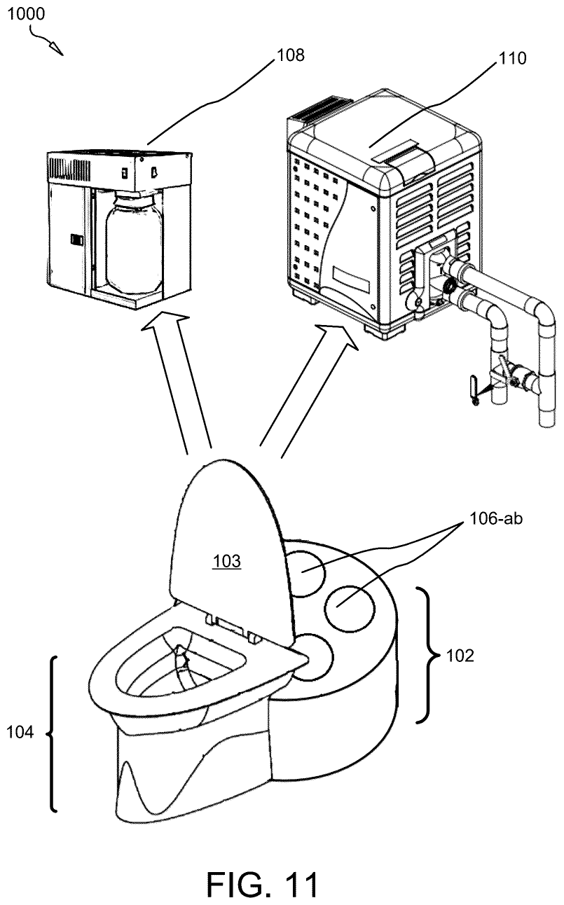

FIG. 11 is an elevational frontal-side perspective view of a multifunction toilet apparatus 1100 and system for in accordance with the present invention.

In various embodiments, the apparatus 100 comprises a toilet bowl 104 partially disposed over cylinder 102 which defines and/or comprises a plurality of crucibles 106 (i.e., chambers) operable to hold human waste, including urine, defecation, and hygiene items such as toilet paper and water (collectively the “waste material”).

The cylinder 102 is operable to revolve around a central axis point mechanically, electrically or electromechanically and rotate a crucible 106 (i.e. chamber) from a position under the toilet 104 around the central axis to a rearward position where the waste material's incineration cycle is complete, and the waste material has largely been incinerated into soot, ash or cinder. The waste material is then deposited inferiorly into a lower waste disposable container or receptacle 402.

In some embodiments, the heat, typically generating from combustible organic material such as natural gas, petroleum or wood, is recycled within the apparatus to provide heat to a water distillation apparatus 108 and/or a central heating unit 110 for a residential or commercial building.

In various embodiments, ground water 414 is injected into the system 600 for use in flushing the toilet 104, cleaning emptied crucibles 106, injection into the distillation apparatus 108 for use in converting to distilled water, and/or cooling emptied crucibles 106.

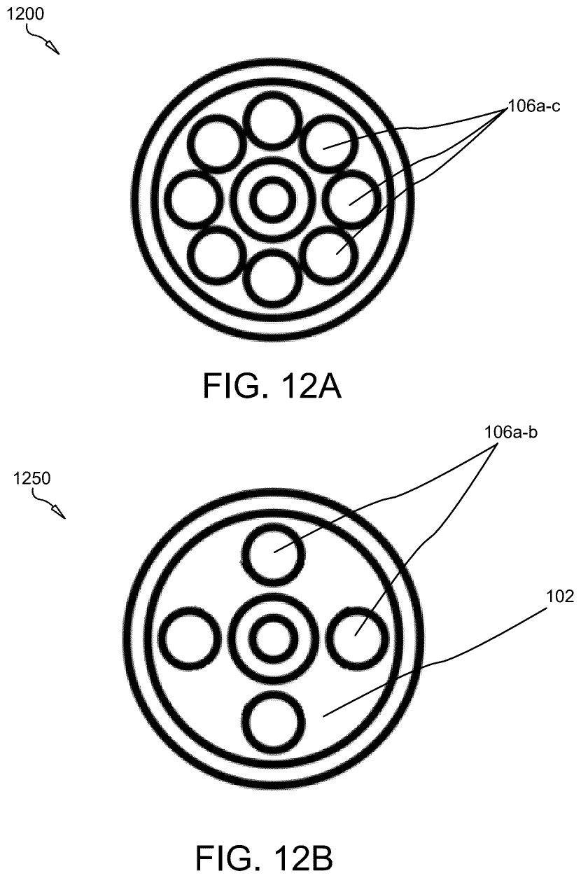

FIG. 12A is a top perspective view of a cylinder of multifunction toilet apparatus 1200 and system for in accordance with the present invention.

In various embodiments, the cylinder 102 comprises a plurality of crucibles 106a-c. These crucibles 106 may be disposed at regular intervals around a perimeter of the cylinder 102. In various embodiments, the cylinder comprises eight crucibles, each housing waste in a separate stage in incineration.

FIG. 12B is a top perspective view of a cylinder of a multifunction toilet apparatus 1250 and system for in accordance with the present invention.

In other embodiments, the cylinder 102 comprises four crucibles 106.

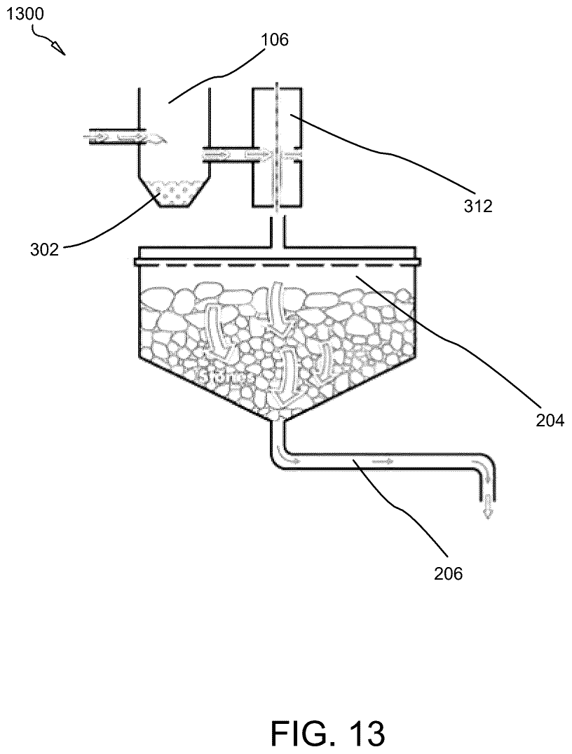

FIG. 13 is a sectioned side perspective view of a multifunction toilet system 1300 for in accordance with the present invention.

The rearward crucible 106 deposits waste 302 into a waste disposal receptacle 204. In various embodiments, the waste disposal receptacle 204 comprises or consists of simply a hole in the ground or field drain, but also comprise a septic tank. In various embodiments, a drain 206 positions beneath the waste disposal receptacle 204.

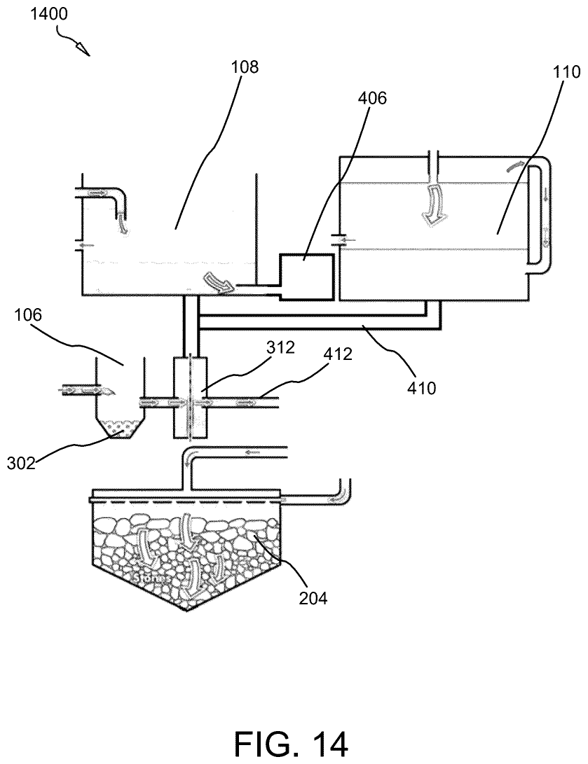

FIG. 14 is a sectioned side perspective view of a multifunction toilet system 1400 for in accordance with the present invention.

The incinerated human waste 302 may be incinerated using natural gas 412 or propane in combustion chamber 312. Heated gases 410 from this combustion chamber 312 may be directed to the water distillation apparatus 108 and/or a central heating unit 110. In various embodiments, the heated gases are also directed to other systems within a household, such as oven, air conditioning units, and the like.

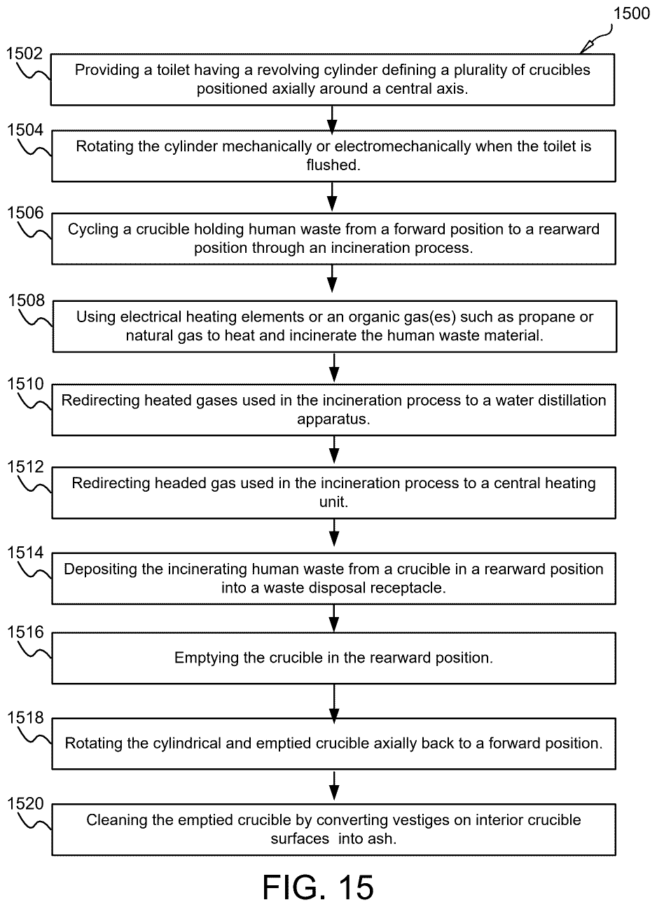

FIG. 15 is a flowchart of a method purposing heat for beneficial processing of human waste in accordance with the present invention.

As shown.

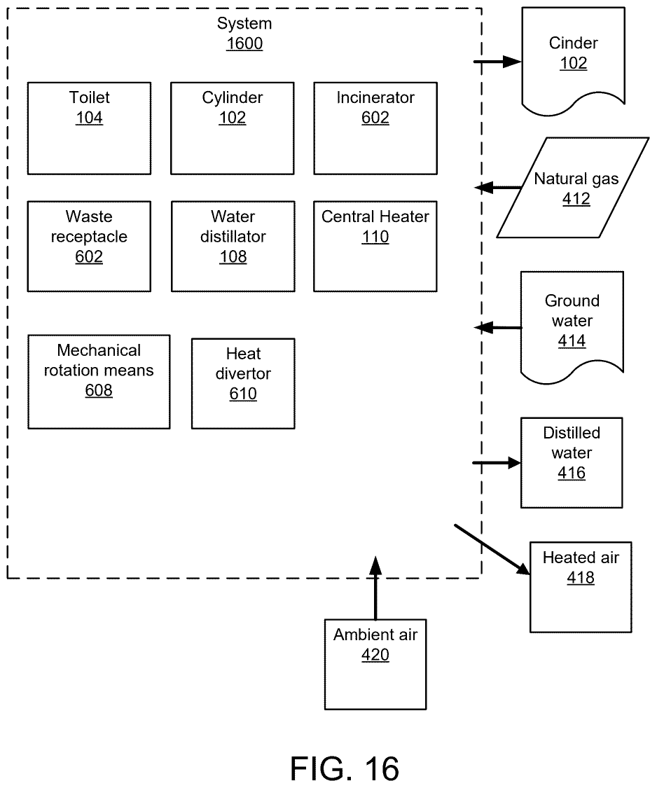

FIG. 16 is a block diagram of a system 1600 purposing heat for beneficial processing of human waste in accordance with the present invention.

In various embodiments, the system 1600 comprises mechanical rotation means activated by flushing the toilet 104 and divertor 610 operable to divert exhaust or heat used in the incinerator to one or more of a distillation apparatus 108 and a central heater 110.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A multifunction toilet, the toilet comprising:
a toilet bowl defining a hollowing cylindrical recess dimension to receive a chamber wheel;
a cylinder defining a plurality of concave crucibles positioned at regularly-spaced intervals around a central axis of the cylinder, each crucible defining an open top end;
wherein the cylinder is partially disposed beneath a receptacle of the toilet bowl;
wherein the cylinder is operable to rotate when a lid is closed and to cycle the crucible;
wherein the toilet bowl defines a hollow interior cooling recess operable to cool a temperature of an adjacent crucible;
wherein the toilet bowl defines a hollow interior heating chamber operable to heat a temperature of an adjacent crucible;
and a dispenser operable to dispense incinerated human waste material into a waste disposal receptacle.

2. The multifunction toilet of claim 1, wherein the cylinder rotates about a horizontal axis.

3. The multifunction toilet of claim 1, wherein the cylinder rotates about a vertical axis.

4. The multifunction toilet of claim 1, further comprises an incinerator operable to incinerate human waste material in a crucible.

5. The multifunction toilet of claim 1, further comprising a water distillation apparatus heated by exhaust from the incinerator.

6. The multifunction toilet of claim 1, further comprising a central heater heated by exhaust from the incinerator.

7. A multifunction toilet, the toilet comprising:
a toilet bowl defining a hollowing cylindrical recess dimension to receive a chamber wheel;
a cylinder defining a plurality of concave crucibles positioned at regularly-spaced intervals around a central horizontal axis of the cylinder, each crucible defining an open top end;
wherein the cylinder is partially disposed beneath a receptacle of the toilet bowl;
wherein the cylinder is operable to rotate when a lid is closed and to cycle the crucible;
wherein the toilet bowl defines a hollow interior cooling recess operable to cool a temperature of an adjacent crucible;
wherein the toilet bowl defines a hollow interior heating chamber operable to heat a temperature of an adjacent crucible, the hollow interior heating chamber surrounded by heating elements;
and a dispenser operable to dispense incinerated human waste material into a waste disposal receptacle.

8. The multifunction toilet of claim 7, further comprising a water tank filled with vapor from one of: evaporated human waste and an external water supply.

9. The multifunction toilet of claim 8, further comprising a valve for inputting water into the toilet.

10. The multifunction toilet of claim 7, wherein the heating chamber defines a drainage opening connected to a drain pipe.
